(19) United States
(12) Patent Application Publication
(10) Pub. No.: US 2017/0111389 A1
(43) Pub. Date: Apr. 20, 2017

(54) METHOD AND SYSTEM FOR PROTECTING DOMAIN NAME SYSTEM SERVERS AGAINST DISTRIBUTED DENIAL OF SERVICE ATTACKS

(71) Applicant: NXLabs Limited, Tortola (VG)

(72) Inventors: Juniman Kasman, Hong Kong (HK); Xiaohai Lu, Hong Kong (HK); Jinping Zhang, Hong Kong (HK); Tianyi Liu, Hong Kong (HK); Ryan Chin, Hong Kong (HK)

(21) Appl. No.: 14/886,060

(22) Filed: Oct. 18, 2015

(51) Int. Cl. H04L 29/06; G06F 17/30; H04L 29/12

(52) U.S. Cl. CPC H04L 63/1458; H04L 61/1576; H04L 61/1511; H04L 63/1416; G06F 17/30949; G06F 17/30979

(57) ABSTRACT

A DNS server DDoS attack mitigation system is provided, comprising a DNS cache module. A DNS query or UDP data packet from an originating source intended for a DNS server is to be diverted to the DNS cache module. The DNS cache module validates the DNS query or UDP data packet and discard it if it is malformed. The DNS cache module then extracts from the DNS query or UDP data packet a domain name and virtual IP address (VIP) of the requested destination resource, and source IP (SIP). Using the domain name, VIP, and SIP to find and retrieve from its cache the matching DNS record and respond with a response message according the matched DNS record type. If a match is not found, the DNS query or UDP data packet is dropped, dropped and responded to with a customizable message, or forwarded to the DNS server.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to systems and methods of protecting against distributed denial of service (DDoS) attacks in computing, electronic, mobile, and data communication networks. More particularly, the present invention relates to the protection of Domain Name System (DNS) servers against DDoS attacks.

### BACKGROUND

A distributed denial of service (DDoS) attack is an attempt to make a computer server device or network resource unavailable to its intended users. A common form of DDoS attack is to use one or more computing devices running self-executing computer instructions (generally referred to as “bots”) to repeatedly send bogus data communication messages in heavy volume to a targeted computer server device or network resource. These bogus data communication messages often are to request for services from the targeted computer server device or network resource. The goal is to saturate the network bandwidth or computing capacity of the targeted computer server device or network resource in its attempt to provide the services requested in respond to the bogus data communication messages.

A Domain Name System (DNS) server is a vital component in networks based on the Transmission Control Protocol/Internet Protocol (TCP/IP) standard. DNS is a hierarchical distributed naming system for computer server devices and resources in a network. A DNS server generally serves to translate a domain name, which is human readable and easy to remember, to a real physical numerical addresses (e.g. IP addresses) and data needed to identify and access the destination computer server device or resource referred to by the domain name.

One form of DDoS attack on a DNS server is to overwhelm the DNS server with large number of bogus DNS queries or requests for domain name translation in a short period of time. One way to mitigate such DDoS attack is to replicate the DNS server into a cluster of DNS servers to expand its processing bandwidth and data throughput to handle bursts of incoming data traffic. But such solution is resource intensive, and not scalable in view of ever more sizable and vicious attacks. It is also economically unfeasible for some DNS server operators to deploy and maintain their own DDoS mitigation facilities.

### SUMMARY

It is an objective of the presently claimed invention to provide a method and a system for protecting a DNS server against DDoS attacks, wherein said system can be deployed separately from the DNS server and that said system can be used to protect a plurality of DNS servers. It is a further objective of the presently claimed invention to provide such method and system that intelligently filters and blocks bogus DNS queries or requests for domain name translation targeting a DNS server.

In accordance to various embodiments of the present invention, the method and the system for protecting DNS server against DDoS attacks can be applied to networks based on the TCP/IP standard. An ordinarily skilled person in the art can appreciated that the inventive concept can be adapted to networks based on other standards with minor modifications not deviated from the underlying inventive concept.

In accordance with one aspect of the present invention, a DNS server DDoS attack mitigation system is provided, comprising a DNS cache module. The DNS cache module can be implemented by a central processing server having at least a central processing unit configured to execute machine instructions. The central processing server is equipped with at least a volatile and/or non-volatile memory module for storing DNS lookup record data and other meta data for use in processing DNS queries and User Datagram Protocol (UDP) data packets for matching the domain names or virtual IP addresses there within to the real physical IP addresses of the requested destination resources.

In accordance with another aspect of the present invention, a DNS server DDoS attack mitigation process is provided, comprising: diverting a DNS query or UDP data packet that is to be processed by a DNS server, to the DNS cache module; receiving, by the DNS cache module, the DNS query or UDP data packet; discarding the DNS query or UDP data packet if it is malformed; matching the DNS query or UDP data packet with DNS records and meta data stored in the DNS cache module using a domain name, a virtual IP address (VIP), and/or a source IP address (SIP) extracted from the DNS query or UDP data packet; if a match is found, the DNS cache module responding to the DNS query or UDP data packet originating source with a response message according the matched DNS record type; if a match is not found, DNS query or UDP data packet is being a.) dropped, b.) dropped and responded to with a customizable message, or c.) forwarded to the DNS server.

In accordance with one embodiment, in the case that the DNS query or UDP data packet cannot be matched with a DNS record in the DNS cache module, the decision of whether to drop the DNS query or UDP data packet, drop the DNS query or UDP data packet and respond to the DNS query or UDP data packet originating source (e.g. an end-user's desktop computer) with a customizable message, or forward the DNS query or UDP data packet to the DNS server is based on system configuration of the DNS cache module.

In accordance to another aspect of the present invention, the decision on forwarding the DNS query or UDP data packet to the DNS server can be further conditioned by one or more rate-limiting functions. A first rate-limiting function is such that DNS queries or UDP data packets are allowed to be forwarded to the DNS server for translation only if the rate of request (e.g. number of request per second) for the same VIP within the DNS queries or UDP data packets does not exceed a first threshold. A second rate-limiting function is such that DNS queries or UDP data packets originating from any particular originating source are allowed to be forwarded to the DNS server for translation only if the rate of request (e.g. number of request per second) from the same originating source (e.g. same SIP) does not exceed a second threshold.

A third rate-limiting function is such that DNS queries or UDP data packets are allowed to be forwarded to the DNS server for translation only if the rate of request (e.g. number of request per second) for the DNS zone of which the domain names belong to does not exceed a third threshold. A forth rate-limiting function is such that DNS queries or UDP data packets are allowed to be forwarded to the DNS server for translation only if the rate of request (e.g. number of request per second) for the DNS record corresponding to the domain names in the DNS queries or UDP data packets does not exceed a forth threshold.

### BRIEF DESCRIPTION OF THE DRAWINGS

Embodiments of the invention are described in more detail hereinafter with reference to the drawings, in which

FIG. 1 shows a block diagram illustrating an exemplary embodiment of a computing environment that the presently claimed DNS server DDoS mitigation system is applicable; and

FIG. 2 shows a logical diagram illustrating the process steps of the DNS server DDoS mitigation process in accordance to one embodiment of the present invention.

### DETAILED DESCRIPTION

In the following description, methods and systems for protecting DNS servers against DDoS attacks and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

DNS Server DDoS Mitigation System:

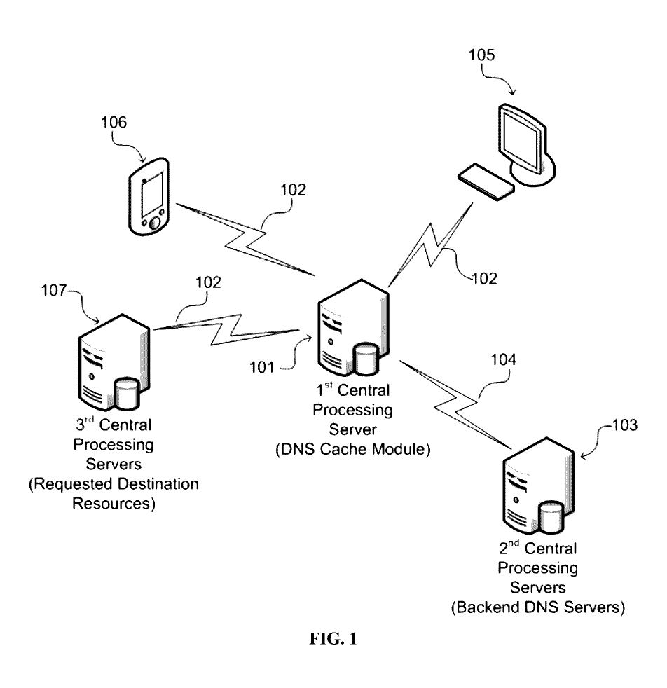

Referring to FIG. 1. In accordance with various embodiments, the presently claimed invention is applicable in a computing environment comprising: a first central processing server (or a first cluster of multiple processing servers) 101 designated for a DNS cache module and accessible through a first communication network 102, which can be the Internet, a telecommunication network, or any network supporting the TCP/IP protocol; one or more second central processing servers (or one or more second clusters of multiple processing servers) 103 designated for one or more backend DNS servers and connected to the first central processing server 101 through a second communication network 104, wherein the second communication network 104 can be the same as the first communication network 102; a plurality of client users using various devices including desktop and laptop computers 105 running conventional Internet browser software applications to access the services provided by the second central processing server 103, and mobile communication devices 106 running mobile versions of Internet browser software applications to access the services and/or resources (e.g. an URL) provided by one or more third central processing servers (or one or more third clusters of multiple processing servers) 107 designated as the requested destination resources. In accordance to one embodiment, the requested destination resources are grouped into one or more groups of requested destination resources.

The first central processing server 101 can run in Layer 2 Transparent mode, which rely on a network router to forward data traffic to the requested destination resources determined from the processing of the DNS queries and User Datagram Protocol (UDP) data packets. Alternatively, the first central processing server 101 can run in Layer 3 Routing mode to internally route data traffic to the requested destination resources determined from the processing of the DNS queries and User Datagram Protocol (UDP) data packets.

The first central processing server 101 comprises at least a central processing unit configured to execute machine instructions. The central processing server is equipped with at least a volatile and/or non-volatile memory module for storing DNS lookup record data and other meta data for use in processing DNS queries and User Datagram Protocol (UDP) data packets for matching the domain names or virtual IP addresses there within to the real physical IP addresses of the requested destination resources.

DNS Server DDoS Mitigation Process:

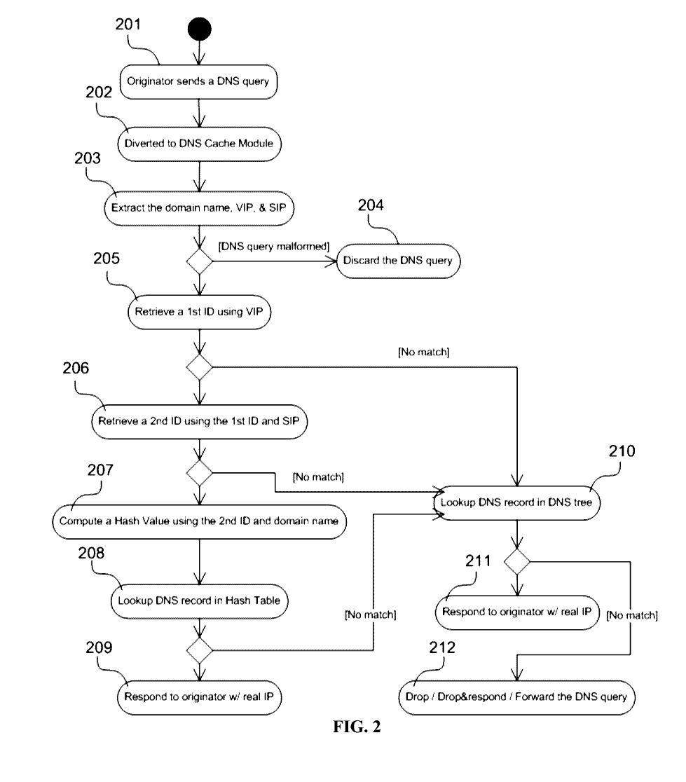

Referring to FIG. 2. In accordance with various embodiments, the presently claimed invention includes a DNS server DDoS mitigation process executed by the DNS cache module of the DNS server DDoS attack mitigation system, the DDoS mitigation process comprising the following process steps:

1.) (201) An originating source (e.g. a client user's computing device) sends a DNS query or UDP data packet to a DNS server for translation (DNS lookup) into a real physical IP address of the requested destination resource, wherein the DNS query or UDP data packet contains at least a domain name and/or VIP of the requested destination resource and the SIP of the originating source.

2.) (202) The DNS query or UDP data packet is diverted to the DNS cache module; and the DNS cache module receives the DNS query or UDP data packet.

3.) (203) The DNS cache module parses the DNS query or UDP data packet and extract the domain name and VIP of the requested destination resource, and the SIP of the originating source.

4.) (204) The DNS cache module discards the DNS query or UDP data packet if it is malformed, that is no validly formatted domain name or VIP of the requested destination resource, or the SIP of the originating source can be extracted.

5.) (205) The DNS cache module uses the VIP to find in a first table a reference to a first data record containing information, including a first identifier, wherein the first table and the first data record are stored in a volatile or non-volatile memory accessible by the DNS cache module, wherein each VIP has its own corresponding first data record, and wherein the first identifier is to identify the group of requested destination resources among which existed a requested destination resource that the VIP is mapped to.

6.) (206) The DNS cache module uses the SIP to find in the first table a reference to a second table containing pairs of first identifiers and second identifiers, and finds in the second table a second identifier corresponding to a first identifier matching to the first identifier found in the above step, wherein the second table is stored in the volatile or non-volatile memory accessible by the DNS cache module, wherein each SIP or range of SIP's (e.g. 1.2.3.* and 1.2.3.0/24, which is equivalent to {1.2.3.0, 1.2.3.1, . . . , 1.2.3.23}) has its own corresponding second table that contains pairs of first identifiers and second identifiers for second-identifier-lookup using first identifiers, and wherein each SIP has its own corresponding second table.

7.) (207) With the matched second identifier, and the extracted domain name, the DNS cache module computes a harsh value according to:
Harsh Value=Hash(Combine([domain name], [second identifier]), hash key), where the hash key is an alpha-numeric value stored in the volatile or non-volatile memory accessible by the DNS cache module.
   In accordance to one embodiment, the combining of the domain name and second identifier is the concatenation of the domain name, followed by a middle character such as “_”, and followed by the second identifier such that:
Combine([domain name], [second identifier])=[domain name]_[second identifier].

8.) (208) The DNS cache module uses the computed hash value to find in a third table (hash table) a DNS record by matching the computed hash value to one of the recoded hash values in the hash table, wherein the hash table is stored in the volatile or non-volatile memory accessible by the DNS cache module, wherein each third table is associated with the group of requested destination resources among which existed a requested destination resource that the VIP is mapped to, wherein each hash table contains pairs of hash values and DNS records for DNS-record-lookup using hash values, and wherein the DNS record contain the real physical IP address of the requested destination resource.

9.) (209) The DNS cache module responds to the DNS query or UDP data packet originating source with the real physical IP address of the requested destination resource.

10.) (210) If any one of steps 5-8 fails to find a match, then the DNS cache module uses the second identifier and the domain name to lookup the DNS record through a DNS tree, wherein the DNS tree is a logical tree-like data structure stored in the volatile or non-volatile memory accessible by the DNS cache module, and wherein the DNS record contain the real physical IP address of the requested destination resource. The DNS tree can be same as a conventional DNS tree maintained by a conventional DNS server.

11.) (211) The DNS cache module responds to the DNS query or UDP data packet originating source with the real physical IP address of the requested destination resource.

12.) (212) If step 10 fails to find a match, the DNS cache module, according to a system configuration, a) drops the DNS query or UDP data packet, b.) drops and responds to the DNS query or UDP data packet originating source with a customizable message, or c.) forwards the DNS query or UDP data packet to the DNS server.

In accordance to another aspect of the present invention, the decision on forwarding the DNS query or UDP data packet to the DNS server can be further conditioned by one or more rate-limiting functions. A first rate-limiting function is such that DNS queries or UDP data packets are allowed to be forwarded to the DNS server for translation only if the rate of request (e.g. number of request per second) for the same VIP within the DNS queries or UDP data packets does not exceed a first threshold. A second rate-limiting function is such that DNS queries or UDP data packets originating from any particular originating source are allowed to be forwarded to the DNS server for translation only if the rate of request (e.g. number of request per second) from the same originating source (e.g. same SIP) does not exceed a second threshold.

A third rate-limiting function is such that DNS queries or UDP data packets are allowed to be forwarded to the DNS server for translation only if the rate of request (e.g. number of request per second) for the DNS zone of which the domain names belong to does not exceed a third threshold. A forth rate-limiting function is such that DNS queries or UDP data packets are allowed to be forwarded to the DNS server for translation only if the rate of request (e.g. number of request per second) for the DNS record corresponding to the domain names in the DNS queries or UDP data packets does not exceed a forth threshold.

In accordance to another aspect of the present invention, the DNS cache module allows the update of its cached DNS records a single record at a time, a DNS zone batch at a time, or all DNS records for each group of requested destination resources. Since the primary DNS lookup is by the third tables, to facilitate the DNS zone batch update, all hash value and DNS record pairs of the same DNS zone are doubly linked to each other.

The embodiments disclosed herein may be implemented using general purpose or specialized computing devices, mobile communication devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, mobile communication devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Exemplary embodiments of mobile communication devices include, but are not limited to, mobile telephones, mobile telephones with personal computer like capability (commonly referred to as “smartphones”), electronic personal digital assistants (PDAs), portable computers with wired or wireless wide-area-network and/or telecommunication capability such as tablet personal computers and “netbook” personal computers.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A computer implemented method for mitigating distributed denial of service (DDoS) attacks against domain name system (DNS) servers, comprising:
diverting a DNS query or UDP data packet that is to be processed by a DNS server, to a DNS cache module;
receiving, by the DNS cache module, the DNS query or UDP data packet;
discarding, by the DNS cache module, the DNS query or UDP data packet if it is malformed;
extracting, by the DNS cache module, from the DNS query or UDP data packet, a domain name of a requested destination resource, a virtual IP (VIP) of the requested destination resource, and a source IP (SIP) of the DNS query or UDP data packet originating source;
matching, by the DNS cache module, the domain name, VIP, and SIP to DNS records and meta data stored in the DNS cache module and retrieving the matched DNS record;
if a match is found, the DNS cache module responding to the DNS query or UDP data packet originating source with a response message based on the matched DNS record type;
if a match is not found, DNS query or UDP data packet is being
a.) dropped,
b.) dropped and responded to with a customizable message, or
c.) forwarded to the DNS server.

2. The method of claim 1, wherein the matching of the domain name, VIP, and SIP to DNS records and meta data stored in the DNS cache module and retrieving the matched DNS record comprising:
retrieving a first identifier using the VIP;
retrieving a second identifier using the first identifier and the SIP;
generating a hash value by hashing a combination of the domain name and the second identifier; and
retrieving from a hash table stored in the DNS cache module a matched DNS record by matching the hash value with records in the hash table.

3. The method of claim 1, wherein the matching of the domain name, VIP, and SIP to DNS records and meta data stored in the DNS cache module and retrieving the matched DNS record comprising:
retrieving a first identifier using the VIP;
retrieving a second identifier using the first identifier and the SIP;
retrieving from a DNS tree stored in the DNS cache module a matched DNS record by traversing the DNS tree nodes using the domain name and the second identifier.

4. The method of claim 1, wherein the forwarding of the DNS query or UDP data packet to the DNS server if a matching DNS record is not found comprising:
forwarding the DNS query or UDP data packet to the DNS server only if a rate of request for the VIP does not exceed a threshold.

5. The method of claim 1, wherein the forwarding of the DNS query or UDP data packet to the DNS server if a matching DNS record is not found comprising:
forwarding the DNS query or UDP data packet to the DNS server only if a rate of request for the SIP does not exceed a threshold.

6. The method of claim 1, wherein the forwarding of the DNS query or UDP data packet to the DNS server if a matching DNS record is not found comprising:
forwarding the DNS query or UDP data packet to the DNS server only if a rate of request for a DNS zone of which the domain name belongs to does not exceed a threshold.

7. The method of claim 1, wherein the forwarding of the DNS query or UDP data packet to the DNS server if a matching DNS record is not found comprising:
forwarding the DNS query or UDP data packet to the DNS server only if a rate of request for a DNS record corresponding to the domain name does not exceed a threshold.
